(19) United States
(12) Patent Application Publication
(10) Pub. No.: US 2010/0199833 A1
(43) Pub. Date: Aug. 12, 2010

(54) Method and System for Creating Customized Sound Recordings Using Interchangeable Elements

(76) Inventor: Brian McNaboe, Seattle, WA (US)

Correspondence Address: Brian McNaboe, 4614 Dayton Ave N, Seattle, WA, 98103, US

(21) Appl. No.: 12/701,605

(22) Filed: Feb. 8, 2010

Related U.S. Application Data
(60) Provisional application No. 61/150,893, filed on Feb. 9, 2009.

(51) Int. Cl. G10H 1/08

(52) U.S. Cl. 84/625

(57) ABSTRACT

A method and system that automatically generates customized recorded music by intelligently selecting and assembling component audio elements from a set of interchangeable elements that are known to be musically compatible. It utilizes explicit and inferred audience preferences data in selecting, and even modifying in real-time, the delivered audio over a computer network.

### CROSS-REFERENCE TO RELATED APPLICATIONS

This application claims the benefit of U.S. Provisional Patent Application No. 61/150,893 filed Feb. 9, 2009 which is hereby incorporated by reference herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates generally to the formation of customized audio recordings and particularly to the creation of custom music.

Music recordings are often created by first recording a plurality of elements of a song, grouped by instrumentation, and then combining them using studio processes into a single “mixed-down” representation of the song. For example, a song recording by a musical group may be created by first individually recording vocal, guitar, drums, bass and keyboard performances as distinct sound recordings. These elements are then combined by studio professionals into a sound recording that can be made available to listeners as a single cohesive work (possibly in multi-channel stereo format), often distributed in the form of a vinyl record, compact disc, MP3 or streamed over the internet. This approach allows artists, producers and recording engineers flexibility during the creation process, and simplified distribution and playback after mix-down.

Once a song has been mixed-down into its final distributable state, it is extremely difficult to cleanly separate back out, or disentangle, the originally discrete contributing elements for inspection, remixing, customization or any other purpose. In this traditional approach relatively few song variations are readily available to music consumers, and they have limited ability to modify or customize the basic song recording once it has reached this mixed-down state. Thus, song flexibility for consumers is relatively restricted with very limited ability to customize a song to personal taste or other requirements. Furthermore, marketing and revenue opportunities for content creators, rights holders, music services providers and others are similarly confined.

Although there exists music recommendation systems that attempt to match the listener's preferences to the music being played, many operate at a macro-level. An example is Pandora Internet Radio, by Pandora Media, Inc. In general, song recommendation systems attempt to automatically select songs from a collection of available songs based on explicit or implicit preference information for the listener. However, they have no ability to make micro adjustments to the song itself to further personalize the experience or even allow a user to significantly personalize the song himself.

To the other extreme, there are also products that allow the user full and complete control over the composition of a song by allowing them to work with the song elements prior to mix-down. This allows for maximum flexibility and creative control in the song creation process. The most powerful products available for working with song elements directly can be grouped into a class of software applications known as digital audio workstations. Two such applications are Pro Tools, by Avid Technology Inc., and Logic Pro, by Apple Inc. These tools are most often used by studio professional and require significant training and experience to use properly.

There also exist systems that allow a user to manually select sound elements to be included within a song. Available elements may or may not be limited to those with a natural musical fit (for example, based on key or rhythmic matches). Furthermore, these systems may or may not allow a user to modify the song while it's playing. Although such a system does allow a user some flexibility to customize a song and requires little or no training, it is still a somewhat manual process requiring the user to be actively involved in each modification.

A problem with existing art in the field of automatic song creation, such as described in U.S. Pat. No. 6,404,893 entitled “Method for producing soundtracks and background music tracks, for recreational purposes in places such as discotheques and the like” by Enrico lori issued in June, 2002, is that that they do not sufficiently account for user preferences, generally leading to generic and less personally appealing results.

### BRIEF SUMMARY

It is therefore an object of the present invention to provide a method and system whereby a consumer with no music training or ability can generate and access customized songs per personal taste or other requirements.

The method takes as input all relevant audience preference and song requirements data and available song component data as well as any pertinent contextual information, and attempts to find a best fit match between audience, content and context. The method accomplishes this task through the use of a dynamic and adaptable decision matrix. Elements of computer artificial intelligence and aggregate user data are leveraged to evolve and adapt the song customization algorithm over time. Once configured, the song customization process can operate in a near fully automatic mode and endeavors to “learn” from ongoing user interaction.

The system takes advantage of standard multi-tiered web application architecture to deliver the customized music experience to audiences via computer network connected user interfaces. Devices with access to the service include, but are not limited to, personal computers and mobile devices. Content is delivered over the network in the form of streaming audio, and may also be available in downloaded audio file format(s).

In this way, the method and system as described in more detail below, creates new opportunities for music related commerce and audience satisfaction by dramatically lowering the music customization barriers for the typical consumer.

### BRIEF DESCRIPTION OF THE DRAWINGS

The above and other objects, features and advantages of the invention will become more apparent from reading the following description of the preferred embodiment taken in connection with the accompanying drawings in which:

FIG. 1 is a flow-chart depicting inputs and the output of a song stem selection algorithm

FIG. 2 is a logical representation of a decision matrix for selecting a stem within a given category

FIG. 3 is a block-diagram illustrating high level system architecture

FIG. 4 is a basic example of a user interface to the music customization player

### DETAILED DESCRIPTION OF THE INVENTION

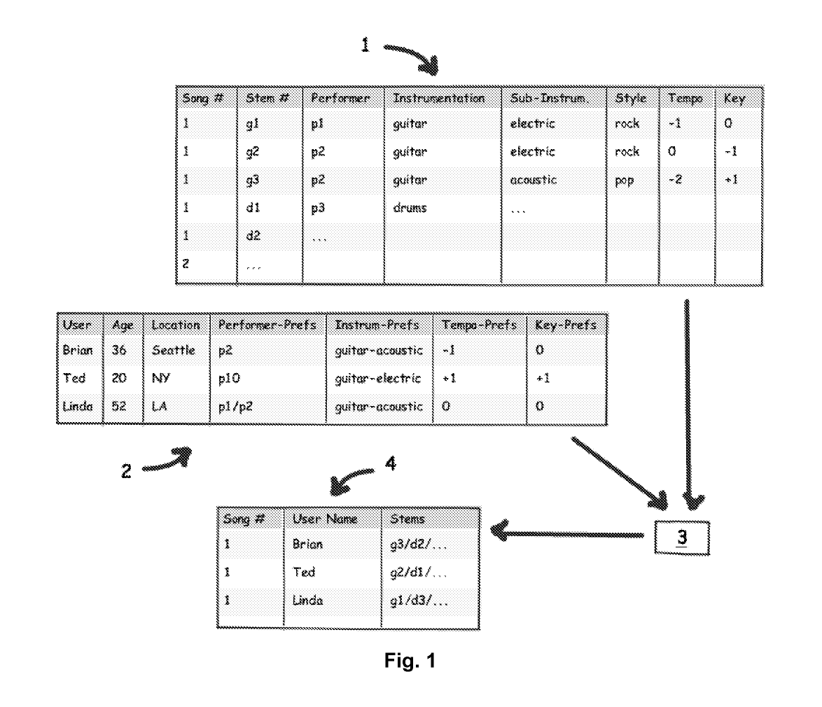

In one preferred embodiment of the method and system, the method as illustrated in FIG. 1, has access to two sets of input data. Song stem data (1) and audience data (2) are fed into the adaptive song customization algorithm (3) which in turn produces a list of the song components to include in the custom song (4). Data is stored durably on a computer system. The system as a whole contains a plurality of songs that are available for customization.

Song stem data (1) consists of the song reference number, a unique stem identifier, primary instrumentation of the stem (e.g. guitar, drums, vocals), sub-instrumentation of the stem (e.g. electric guitar, acoustic guitar), musical style, genre and other performance related characteristics that are factors in audience preference such as stylistic tempo and key variations.

Audience user data (2) includes unique identification, relevant demographic data (e.g. age, gender), current geographic location, place of residence, known musical preferences (e.g. instrumentation/sub-instrumentation, genre, style). It may also be desired to store audience data for generalized groups, such as ‘college students’, particularly when more detailed information is not available.

When generating a custom song variation for a given audience, the customization algorithm (3) takes as input the relevant song stem data (1) and audience data (2), as described above. It also has available contextual information such as the particular song to be customized (either manually selected by the audience, recommended by the system by a process not described herein, or randomly selected from the available list of customizable songs), and audience location and time of day. With these data the customization algorithm attempts to find the best possible match between available song content and audience preferences.

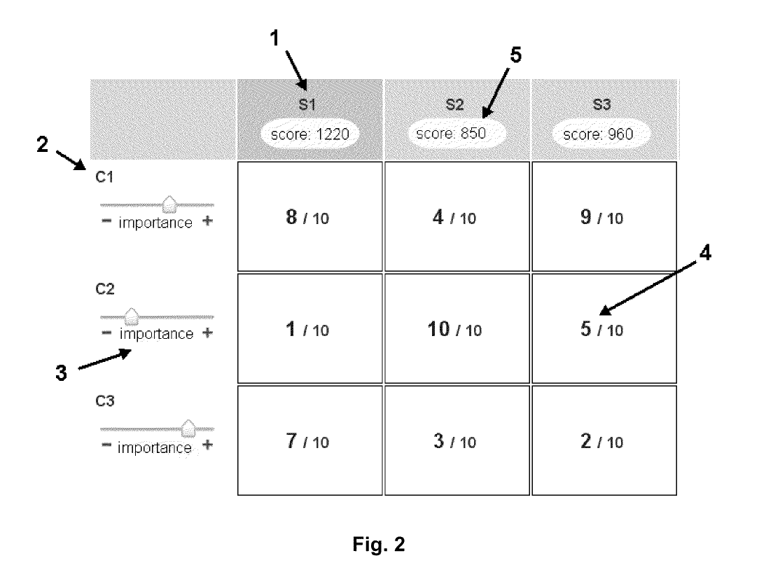

In general, stem selection is accomplished by utilizing an adaptive decision matrix approach on a stem category by category basis as seen in FIG. 2. Stems are categorized by primary instrumentation and role (e.g. drums, lead guitar, backing guitar, lead vocals, backing vocals, etc) and one stem is chosen from each category. The steps are:
1. Determine a song to customize.
2. Select a stem category from those available for the chosen song, SC1, SC2, . . . , SCn.
3. Gather all available stems for that category (1), S1, S2, . . . , Si.
4. Gather all relevant selection criteria (2): C1, C2, . . . , Cj.
5. Assign a numeric weighting factor to each criteria (3).
6. Determine a value for each stem/criteria combination (4), V11, V12, . . . , Vij, in the matrix that represents an evenly scaled measure of the closeness between the desired stem characteristic and the actual characteristic in each criteria multiplied by the associated criteria weighting such that the result is i×j weighted values.
7. Sum the weighted values on a stem by stem basis (5) and select the stem with the highest weighted value for the given stem category.
8. Repeat steps 1-7 for all stem categories, 1 . . . n, resulting in complete set of selected stems for the given song.

The criteria and weightings (3) can change over time based on user feedback and data collected through usage. Principles of computer artificial intelligence are applied to make adjustments to the algorithm. In particular, the use of an artificial neural network with elements of an expert system are used to adjust selection criteria weightings to deliver more desirable results as gauged by explicit and inferred audience satisfaction.

Furthermore, aggregate audience data is used to improve performance by finding similarities between users and allowing the system to draw logical connections. For example, if it's known that audience A and audience B both prefer stems 1, 2, and 3, and audience A also prefers stem 4. Then the method can “lean” towards recommending stem 4 for audience B as well.

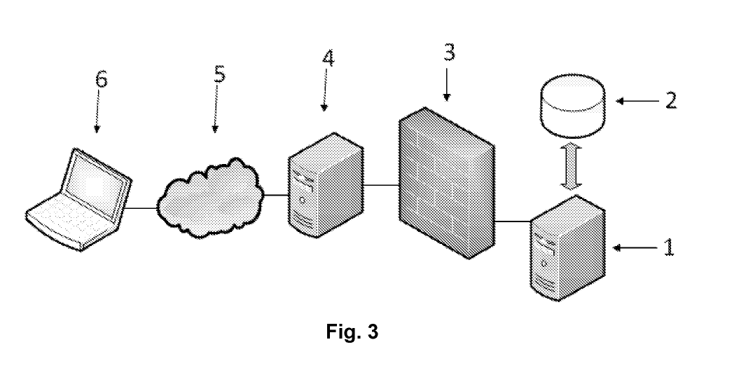

In one preferred embodiment of the system that implements the method described above, as depicted in FIG. 3, there are six primary components. They are: application server (1), database (2), network firewall (3), web server (4), network (5), client terminal (6). This high level system architecture is common in the field of web applications.

The application server (1) is where the selection algorithm operates as a computer software routine. Although represented as a single instance, it is common practice to distribute the processing load across a plurality of physical and logical application servers.

The application server works closely with the database (2) to store and retrieve durable data during the course of handling a user request. The database is responsible for storing all system data including, but not limited to, audience data, stem meta data, selection criteria and current weightings (system wide and on an audience by audience basis). Actual stem audio files, and cached mixed-down audio, can be thought of as stored directly on the application server within an audio file repository. Although it may be desirable to move these files to a dedicated store or even distribute them more closely to system audiences over time and as usage load increases.

The network firewall (3) is in place to limit access to the application server, database and any other internal use only systems. It allows only authorized access, in this case only by the web server (4). The web server is responsible for handling all requests from the network (5). Authorized and well formed requests from the network are passed along (through the firewall) to the application server. Responses are directed back through the network to be delivered to the requestor.

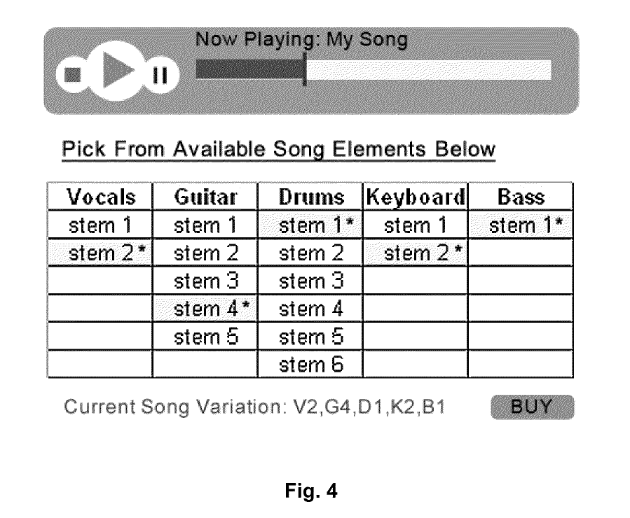

The client terminal (6) is the origination point for the request. This is most often a personal computer but may also be a mobile device. The music customization service is available via a web application and can be accessed from any modern web browser. The client interface is responsible for collecting all necessary data from the audience and providing software controls to the music player, as seen in FIG. 4. As a user interacts with content, and potentially overrides the system's automatically generated content by for example modifying the set of chosen stems, this information is fed back to the method and used in adjusting the selection algorithm as described above.

There can be multiple user and system interfaces to the service as the application “view” is largely independent of the underlying system. There is also an administrative interface that allows authorized users to maintain the system, data and audio file repository.

Using the system described herein, it is possible to factorially increase the amount of custom permutations available with a mere linear increase in the number of interchangeable stems available per song. For example, a song that has 2 vocals, 5 guitar, 6 drums, 2 keyboard and 1 bass parts available can be configured into 120 song variations through permutations of the available parts. Even more can be created by doubling up on parts and dropping others (e.g., choosing two guitar solos and no keyboard). In the preferred embodiment, there is a significant number of interchangeable song stems available to the system for each song, which can easily lead to dozens, hundreds or more readily available variations.

Users can optionally purchase a digital download of the resulting work or otherwise subsidize access to the unique variation (incl. indirectly by being presented with advertisements). The mixed-down song can be delivered as an MP3, ringtone or other music format, or simply streamed digitally over a computer network while the user is connected to the service.

The foregoing is merely illustrative of the principles of this invention and various modifications may be made by those skilled in the art without departing from the scope and spirit of the invention.

What is claimed is:

1. A method of creating customized music whereby a plurality of audio recordings, referred to herein as “stems”, are combined to form a cohesive and pleasing song in accordance with an audience's preferences, characteristics and/or other known audience requirements, comprising the steps of:
a. logically associating meta data with each available stem file, for example instrumentation, artist name(s), tempo, key, musical style, musical genre and mood;
b. grouping stems by instrumentation or other logical categories;
c. collecting audience musical preferences and relevant characteristic data to aid in automated selection process;
d. selecting a plurality of stems, up to one stem from each group, but at least two stems total, by a dynamic and adaptable algorithmic process utilizing audience preferences, characteristics and/or other known audience requirements, to form a musically coherent work when played in unison;

2. The method according to claim 1, where the audio content is not strictly limited to music, but can also include spoken word, commentary, instructions, sound effects and any other type of audio content that can be categorized.

3. The method according to claim 1 or 2, where the customization algorithm can also modify the stems themselves and the overall combined audio using audio effects and other common audio adjustments.

4. The method according to claim 3, where the audience manually selects stems or overrides the dynamically selected stems.

5. The method according to claim 4, where the selection is performed by an adaptive algorithm that leverages artificial intelligence practices to “learn” from the audience manual selection such that it is more likely in the future to make the same or similar selection algorithmically as the audience made manually.

6. The method according to claim 5, where the adaptive algorithm takes into consideration aggregate selection and preference data from a plurality of system audience members.

7. A computer based system for managing, generating and interacting with customized music as described in claim 3, 4, or 5.

8. The system according to claim 7, where the services provided by the system are accessible over a computer network.

9. The system according to claim 7, where the resulting customized song can be converted to a single audio file

10. The system according to claim 9, where the audio file can be downloaded over a computer network by a system user.
